(19) United States
(12) Patent Application Publication
(10) Pub. No.: US 2006/0193339 A1
(43) Pub. Date: Aug. 31, 2006

(54) Wireless communications system

(75) Inventors: Haifeng Wang, Oulu (FI); Jorma Lilleberg, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/247,379

(22) Filed: Oct. 12, 2005

(30) Foreign Application Priority Data
Feb. 25, 2005 (GB) 0503928.4

(51) Int. Cl. H04J 3/22; H04Q 7/24; H04Q 7/00; H04J 3/16

(52) U.S. Cl. 370/465; 370/328; 370/338

(57) ABSTRACT

A wireless communications system comprising: first and second network entities in communication over a wireless channel, the first network entity comprising means for monitoring signal quality and means for transmitting information relating to signal quality over the wireless channel and the second network entity including a transmitter comprising a basic signal processing system for processing a signal for transmission over the wireless channel, and an enhanced signal processing system for processing a signal for transmission over the wireless channel, the network entity being responsive to said information relating to signal quality to select the enhanced system when the signal quality is below a predetermined threshold.

### BACKGROUND OF THE INVENTION

### Field of the Invention

The present invention relates to a wireless communications system in which at least one network entity is in communication with at least one user equipment over a wireless channel.

### SUMMARY OF THE INVENTION

Wireless communications systems of a cellular nature are well known, where a network entity in the form of a base station is responsible for communication with user equipment in one or more cells or sectors. When a user equipment moves from one cell or sector to another cell or sector, handover techniques ensure that the communication is not lost as responsibility is passed to a different base station. There are many different techniques for processing signals for transmission between the base station and the user equipment, and the precise handover techniques which are used depend on these systems. One technique for handling multi-carrier transmissions is orthogonal frequency division multiplexing (OFDM).

Orthogonal frequency-division multiplexing (OFDM) offers the advantages of improved downlink system capacity, coverage and data rates for packet data services with high spectral efficiency due to a nearly rectangular spectrum occupancy and low-cost implementation using the Fast Fourier Transform (FFT). It has been exploited for wideband data communications over mobile radio channels, high bit rate digital subscriber lines (HDSLs), asymmetric digital subscriber lines (ADSLs), digital broadcasting, and wireless local area network (WLAN) in IEEE 802.11n and worldwide interoperability for microwave access (WIMAX) in IEEE 802.16e. OFDM partitions the entire bandwidth into parallel independent sub-carriers to transmit parallel data streams. The relative longer symbol duration and guard interval provide great immunity to intersymbol interference (ISI). Recently it received considerable attention as an air interface for evolution of UMTS mobile radio systems in 3GPP (Third Generation Partnership Protocol) standardization forum.

The frequency re-use factor when implementing handover has great impact on spectrum efficiency. A frequency re-use factor of one has been proposed in 3GPP, where all the frequencies or sub-carriers are used in every sector of adjacent cells. In such OFDM systems with a frequency re-use factor of 1 there will be very strong inter-cell interference particularly for the user equipment (UE) at the cell edge, which might result in a relatively poor performance.

Frequency hopping has been proposed for “reuse-one” OFDM systems (systems with a frequency re-use factor of 1), which enables a full frequency reuse across the neighbouring cells, provides frequency diversity by interleaving and spreading the transmitted sub-carriers over the whole bandwidth, and averages the inter-cell interference as well. However, frequency hopping makes reuse-one OFDM systems not as efficient in spectrum efficiency as in wideband code division multiplier access (WCDMA). The subset of sub-carriers used by specific user equipment implies a lower peak data rate. Additionally, it is also a challenge for radio network control for resource and sub-carriers allocation.

Selective scrambling in frequency domain has been proposed for OFDM to reduce the peak to average power ratio (PAR). A cell specific code is proposed to scramble the signals in frequency domain for fast cell search in orthogonal frequency and code division multiplexing (OFCDM) and multi-carrier CDMA systems. A pseudo-noise (PN) code scrambling in frequency domain has been also applied for user separation in OFDM-CDMA system However, the scrambling in frequency domain cannot suppress the interference impact induced by neighbouring cells for reuse-one OFDM systems.

Time-domain scrambling has been proposed for OFDM in multi-cell environments with reuse factor as one. It has been proved that time scrambling OFDM systems can significantly improve the system throughput by providing frequency diversity and suppressing inter-cell interference impacts. It gives an OFDM system the same spectrum efficiency and peak data rate as in WCDMA system. However, the OFDM systems with time-domain scrambling require two additional FFT operations for descrambling at the receiver and this could be very critical for power consumption, especially in hand-sized terminals.

It is therefore an aim of the invention to provide a system which allows the trade-off between performance gain and power consumption to be optimised or at least improved.

According to one aspect of the invention there is provided a wireless communications system comprising: first and second network entities in communication over a wireless channel, the first network entity comprising means for monitoring signal quality and means for transmitting information relating to signal quality over the wireless channel and the second network entity including a transmitter comprising a basic signal processing system for processing a signal for transmission over the wireless channel, and an enhanced signal processing system for processing a signal for transmission over the wireless channel, the network entity being responsive to said information relating to signal quality to select the enhanced system when the signal quality is below a predetermined threshold.

It is possible that the second network entity already has knowledge of channel state information (CSI) due to reciprocal communications. In that case, there is no need for the first network entity to feed back CSI information via the signalling channel.

According to another aspect of the invention there is provided apparatus for use in a wireless communications system, the apparatus comprising: a transmitter with a basic signal processing system for processing a signal for transmission and an enhanced signal processing system for processing a signal for transmission; and a system switch operable to select said enhanced signal processing system responsive to information relating to signal quality of a communication channel in the wireless communications system.

The apparatus can be a network entity in the form of a base station for example which includes the transmitter and the system switch. Alternatively, the apparatus can be provided by two different network entities, for example a base station providing a transmitter and a radio network controller providing the system switch.

According to another aspect of the invention there is provided a method of processing a signal for transmission over a wireless communication channel in a communications system, the method comprising: detecting information relating to signal quality of the wirless channel; and selecting one of a basic signal processing system and an enhanced signal processing system for processing a signal for transmission over the wireless channel, wherein the enhanced system is selected when the signal quality is below a predetermined threshold.

In the described embodiment, the basic system is an OFDM system without time domain scrambling, and the enhanced system is an OFDM system which includes time domain scrambling. Common processing components can be shared between the systems. Other combinations of systems are possible. For example there could be an OFDM system and a multi-carrier CDMA system where the basic components are shared apart from the enhanced components (for example spreading/dispreading). There could be more than two system with differing quality thresholds for switching between them.

In the following described embodiment, frequency division duplex (FDD) is applied for uplink/downlink communications and time division multiplexing (TDM) is selectively applied for user separation. Different transmission schemes can be adaptively adopted by a radio network controller based on the instantaneous signal quality, as measured by for example channel quality or the distance between the base station and the user equipment. While the user equipment is close to the base station, the geometry value G or signal to interference plus noise ratio (SINR) is relatively high, so there is no need to implement time domain scrambling to provide frequency domain diversity. This avoids the need for using a complicated receiver structure which consumes more power for descrambling. Additionally, the user equipment does not request higher transmission power, so the corresponding transmitted signal from the base station does not induce severe interference to its neighbouring cells, and there is no need for time domain scrambling to make the its induced intercell interference more Gaussian distributed. However, while the user equipment is at the edge of the cell with lower G or SINR values, the specific user equipment signals the base station to scramble the conventional OFDM signals in the time domain. The time domain scrambling provides a specific user equipment frequency diversity and makes the inter-cell interference to the neighbouring cells more Gaussian distributed so that the performance of the other user equipments with a linear receiver structure in the neighbouring cells could also be enhanced.

In the following description, it is assumed that the base station is responsible for selecting the processing system to be used for transmissions based on signal quality measurements received from a user equipment. That is, the downlink transmissions can be modified. However, it will be clear to a person skilled in the art that the principles of the invention can also be applied to the uplink.

### BRIEF DESCRIPTIONS OF THE DRAWINGS

For a better understanding of the present invention and to show how the same may be carried into effect, reference will now be made by way of example to the accompanying drawings in which:

FIG. 1 is a schematic diagram of a cellular wireless communications system;

FIG. 2 is a schematic diagram showing communication between user equipment, base station and radio network controller;

FIG. 3 is a schematic block diagram of a basic signal processing system; and

FIG. 4 is a schematic block diagram of an enhanced signal processing system.

### DESCRIPTION OF THE PREFERRED EMBODIMENTS

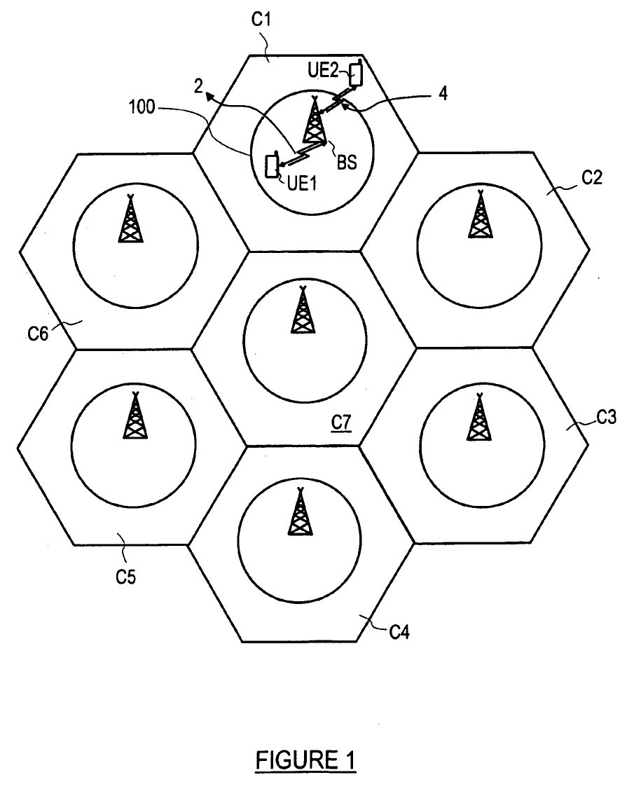

FIG. 1 illustrates a cellular wireless communications network of which seven cells C1 . . . C7 are shown in a “honeycomb” structure. Each cell is shown managed by a base station BS which is responsible for handling communications with user equipment (UE) located in that cell. Although one base station per cell is shown in FIG. 1, it will readily be appreciated that other cellular configurations are possible, for example with a base station controlling three cells. Also, other arrangements are possible, including a network divided into sectors, or a network where each cell is divided into sectors. In cell C1 reference numeral 100 denote a hypothetical circle which is intended to represent a geographical threshold which has a relationship to signal quality for user equipment within the cell. That is, a first user equipment UE1 is shown located within the circle 100, this user equipment UE1 communicating with the base station BS via a wireless channel 2 having an uplink and a downlink. The signal quality over the wireless channel 2 between the base station BS and first user equipment UE1 is considered to lie above a predetermined quality threshold because it lies within the circle 100. Conversely, a second user equipment UE2 communicates with the base station BS via a wireless channel 4, also having an uplink and a downlink, but because the second user equipment UE2 is located outside the circle 100, it is assumed that the signal quality over the wireless channel 4 falls below the predetermined quality threshold.

Note that the hypothetical circle 100 is drawn for diagrammatic and explanatory purposes only. In fact, the measurement of signal quality over the wireless channels 2, 4, can vary due to a number of different factors, including the quality of the channel itself (that is the environmental and physical constraints), interference with signals from neighbouring user equipment, geometric ratio, etc. Signal quality is measured at the user equipment UE using a number of different parameters, including for example geometry ratio G or signal to interference plus noise ratio (SINR).

The base station BS is responsible for processing signals to be communicated to the user equipment UE and as will be described in more detail in the following, the premise underlying the present invention is that it processes the signal differently in dependence on whether the signal quality to the particular user equipment is above or below a predetermined quality threshold.

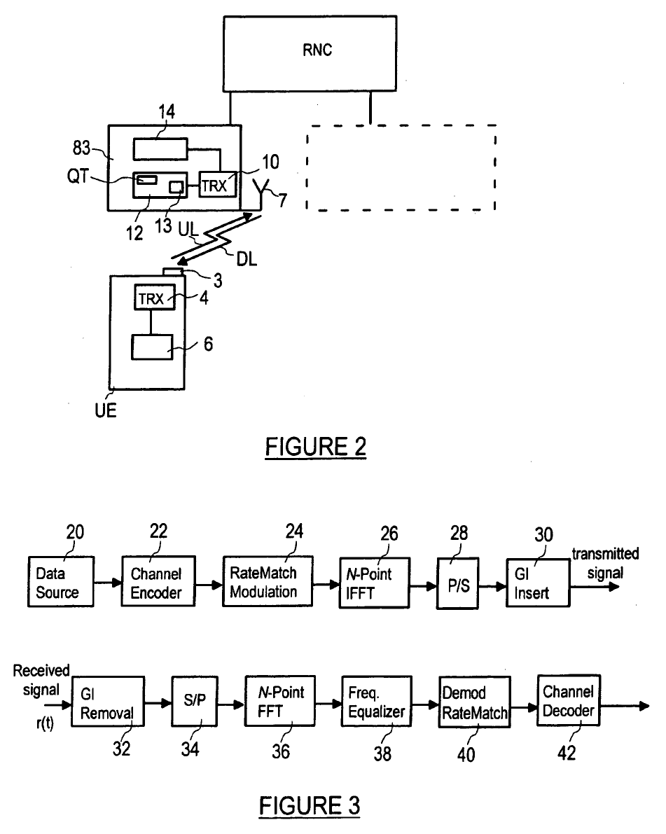

FIG. 2 is a schematic block diagram showing a user equipment in communication with a base station, and also showing a radio network controller RNC which manages the operation of a plurality of base stations in a manner known in the art. Only the operations of the radio network controller RNC pertinent to the present invention are discussed herein. The user equipment UE comprises an antenna 3 connected to a transceiver 4. The user equipment also includes a signal quality monitor 6 which is responsible for determining signal quality of signals received at the antenna 3. The base station also has an antenna 7 connected to a transceiver 10. The base station includes a threshold block 12 which holds a quality threshold value QT which includes a compare circuit for comparing a quality measurement received from the user equipment UE with the quality threshold QT. The base station also includes a system switch 14 which selectively activates one of two signal processing systems present in the transceiver 10. As shown in more detail in the following, the transceiver 10 includes a first, basic signal processing system and a second, enhanced signal processing system.

The radio network controller RNC is connected to the base station BS and to other base stations indicated diagrammatically by the dotted line in FIG. 2 and can be made responsible for setting the quality threshold value QT adaptively, based on activity within the network.

The quality threshold value QT could be any kind of signal quality parameter, including geometry ratio G, signal to interference and noise ratio SINR, packet error statistics, etc. The radio network controller is responsible for optimising overall system throughput, requests from user equipment and related inter/intra-cell interference. Before discussing the architecture of the transceivers 4, 10 in more detail, the manner of operation of the circuits of FIG. 2 will now be described. The user equipment UE receives a signal on the downlink DL of the wireless communications channel. It is processed using the transceiver 4 and the signal quality is measured using the circuit 6. A feedback signalling channel is used on the uplink UL to convey the measured signal quality to the base station BS. The signal received on the uplink is processed by the transceiver 10 of the base station BS and the signal quality parameter is extracted and compared with the quality threshold value QT by the compare circuit 13. If the signal quality is above the quality threshold value QT, the next transmission to be made from the base station to that user equipment on the downlink DL is made using the basic processing system. However, if the signal quality is less than the quality threshold value QT, the system switch 14 switches the transceiver 10 to use the enhanced processing system for the next transmission on the downlink. Thus, reverting to FIG. 1, the circle 100 is intended as a diagrammatic indicator as to when the system switch 14 of the base station switches from using a basic processing system for its downlink transmissions and an enhanced processing system for its downlink transmissions.

Reference will now be made to FIG. 3 to describe a basic signal processing system as used in the transceiver 10 of the base station BS in the form of a conventional OFDM receiver. It will readily be appreciated that the descriptions given herein apply equally to the transceiver 4 at the user equipment.

FIG. 3 shows a block diagram of the conventional OFDM transceiver. The information bits from a data source 20 are encoded at channel encoder 22, rate-matched and modulated (at block 24) based on adaptive modulation and coding (AMC) set. Then the signal is processed by an N-point IFFT 26 such as

$$b ( n ) = IFFT \{ B ( k ) \} = {\sum }_{k = 0}^{N - 1} B ( k ) exp ( j2π kn / N ) n = 0 , 1 , 2 , ⋯ , N - 1 , \qquad ( 1 )$$

where B(k) is the data sequence of length N. Then the output of IFFT is converted from parallel to serial (at P/S block 28), and inserted at block 30 by the redundancy in the form of a guard interval (GI) of length larger than maximum delay spread such as

$$x ( n ) = \{ \begin{matrix} b ( N + n ) , & n = - G , - G + 1 , ⋯ , - 1 \\ b ( n ) , & n = 0 , 1 , 2 , ⋯ , N - 1\end{matrix} , \qquad ( 2 )$$

where x(n) is the transmitted signals, G is the GI length. Finally, GI-added IFFT output x(n) is up-converted at the carrier frequency and transmitted over the frequency-selective fading channel with additive white Gaussian noise (AWGN).
The received signal r(t) is given by
r(t)=h(t)\textcircled{x}x(t)+n(t), (3)
where \textcircled{x} denotes the convolution operation,

$$h ( t ) = {\sum }_{l}^{L} {a}_{l} ( t ) δ ( t - {τ}_{l} )$$

is the channel impulse response in time domain, L is the number of paths, aₜ(t) is the complex channel coefficient at the l^{th} path, τₗ is the tap delay, δ(t) is the delta function, n(t) is the additive white Gaussian noise.

Then the GI is removed at block 32, converted from serial to parallel at S/P block 34 and processed by FFT block 36 as follows

$$\begin{matrix}y ( n ) = r ( n + G ) , n = 0 , 1 , 2 , ⋯ , N - 1. & ( 4 ) \\ Y ( k ) = FFT \{ y ( n ) \} = \frac{1}{N} {\sum }_{n = 0}^{N - 1} y ( n ) exp ( - j2π kn / N ) k = 0 , 1 , 2 , ⋯ , N - 1 & ( 5 )\end{matrix}$$

If the bandwidth of each sub-carrier is much less than the channel coherence bandwidth, a frequency flat channel model can be assumed at each sub-carrier so that only a one-tap equalizer 38 is needed for each sub-carrier at the receiver. With the channel estimates in frequency domain H(k), the received signal can be equalized by zero-forcing detector such as
\hat{B}(k)=(|H(k))⁻¹Y(k)=(|H(k)|²)⁻¹H*(k)Y(k) k=0, 1, 2, . . . , N−1, (6)
or in minimum mean square error (MMSE) criteria such as
\hat{B}(k)=(|H(k)|²+σ²)⁻¹H*(k)Y(k) k=0, 1, 2, . . . , N−1, (7)
where ( )* and | |² denote the complex conjugate operation and power respectively, σ² is the noise variance. Then the equalized signal is demodulated and rate matched in block 40 and then decoded at block 42 correspondingly.

The corresponding discrete-time received signal with GI removal is

$$\begin{matrix}y = {THGF}^{- 1} b + n \\ = {XF}^{- 1} b + n\end{matrix} , \qquad ( 8 )$$

where y is the received signal vector, T is the truncating matrix, H is the matrix with channel impulse response, G is the matrix for GI inserting, F⁻¹ is the IFFT matrix, b is the vector of transmitted symbols and n is the noise vector. Assuming the GI length is larger than maximum delay spread, X=THG is the circular square matrix and can be modelled as
X=F⁻¹H_{f}F, (9)
where H_{f} is the diagonal matrix with channel impulse response in frequency domain, and F is the FFT matrix. Then the received signal with GI removal in (8) can be simplified into
y=F⁻¹H_{f}b+n. (10)

The transmitted signal can be detected by FFT and one-tap zero-forcing channel equalizer such as
\hat{b}=(H_{f})⁻¹Fy. (11)
or in MMSE such as
\hat{b}=(H_{ƒ}|H_{f}|²σ²)⁻¹ (Hƒ)*Fy. (12)

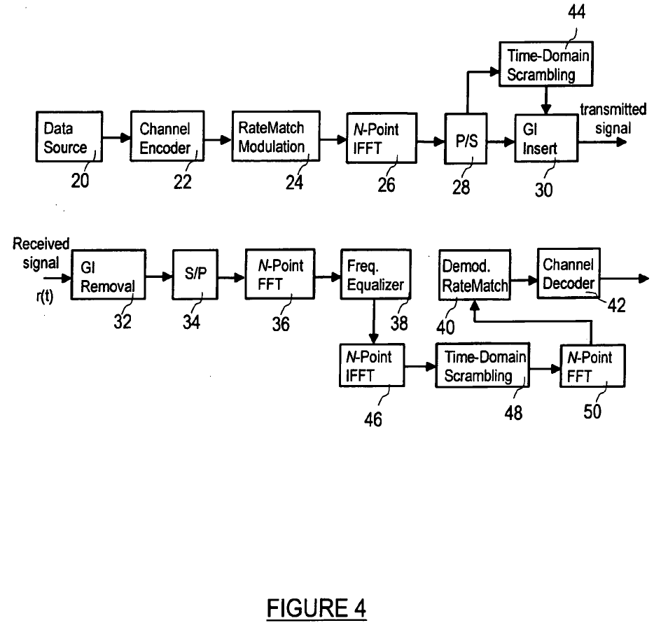

FIG. 4 illustrates a block diagram of an enhanced OFDM transceiver with scrambling in time domain. Like numerals denote like parts as in FIG. 3. The conventional OFDM symbols b(n) after IFFT operation in (1) are scrambled in time domain at scrambler block 44 such as
\hat{b}(n)=cᵢ(n)×b(n) n=0, 1, 2, . . . , N−1, (13)
where cᵢ(n) is the part of the long scrambling sequence corresponding to i^{th} OFDM symbol. The scrambled signal \hat{b}(n) is inserted by GI insert block 30 as in FIG. 3 and then transmitted.

Same as in the conventional OFDM receiver, the received signal r(t) with GI removal at 32 is transformed into frequency domain by FFT operation 36 and equalized at 38 as in FIG. 3. Then the equalized signal is transformed into time domain by IFFT operation in block 46, which implements the same operation as block 26 on the transmit side and the time-domain equalized signal \tilde{b}(n) is descrambled in block 48 by the corresponding scrambling code such as
\overline{b}(n)=cᵢ*(n)×\tilde{b}(n) n=0, 1, 2, . . . , N−1, (14)

Finally the descrambled signal is transformed back into frequency domain by FFT operation at block 50 which implements the same operation as block 36, demodulated, rate-matched and decoded, respectively.

The discrete-time received signal with GI removal in the OFDM transceiver with time-domain scrambling can be written as

$$\begin{matrix}y = {THGCF}^{- 1} b + n \\ = {XCF}^{- 1} b + n\end{matrix} , \qquad ( 15 )$$

where C is the diagonal matrix containing long scrambling code. The corresponding simplified received signal with GI removal is
y=F⁻¹H_{f}FCF⁻b+n. (16)

The received signal is then transformed into frequency domain by FFT and equalized by one-tap zero-forcing channel equalizer such as

$$\begin{matrix}d = {( {H}_{f} )}^{- 1} Fy \\ = {FCF}^{- 1} b + \tilde{n}\end{matrix} . \qquad ( 17 )$$

Then the equalized signal is transformed into time-domain by IFFT, descrambled by corresponding scrambling code, transformed back into frequency domain as
\hat{b}=FC⁻¹F⁻¹d. (18)

Blocks 44, 46, 48 and 50 which implement the additional processing required by the enhanced OFDM transceiver with time domain scrambling are referred to herein an enhancement components. The scrambling and descrambling processing can be easily implemented by N-sized summations. However, additional two FFT operations are still needed comparing to the conventional OFDM system of FIG. 3, i.e. without time-domain scrambling. This could be very critical for power consumption especially in hand-sized terminals.

For this reason, the described embodiment of the present invention implements time domain scrambling only when it is required because of poor signal quality. In other situations the enhancement components are not utilised thereby saving power.

A number of advantages arise from above described embodiment of the present invention. The use of time domain scrambling implements and OFDM system with the same efficiency and peak data rate as wideband co-division multiplexed access (W-CDMA). There is therefore a high spectrum efficiency and peak data rate for a multi-cell environment with a reuse factor of 1. The system throughput in either single or multi-cell environments can be considerably improved by around 5-15% due to frequency diversity and making the inter-cell interference more Gaussian distributed which benefits other user equipment in neighbouring cells with a linear receiver.

The long scrambling code in the time domain can be used to improve the estimates of channel tap delays for frame synchronisation, fast cell searches, etc.

However, the system switch 14 avoids unnecessary scrambling to minimise power consumption for user equipments which have a good instantaneous channel quality.

1. A wireless communications system comprising:
a first network entity comprising
a monitor monitoring a signal quality, and
a first transmitter transmitting information relating to the signal quality over a wireless channel; and
a second network entity comprising
a second transmitter having a basic signal processing system for processing a signal for transmission over the wireless channel, and
an enhanced signal processing system for processing the signal for transmission over the wireless channel, wherein the first and second networks entities are in communication over the wireless channel and the second network entity being responsive to said information relating to the signal quality to select the enhanced system when the signal quality is below a predetermined threshold.

2. A wireless communications system according to claim 1, wherein the first network entity further comprises a user equipment and the second network entity further comprises a base station.

3. A wireless communications system according to claim 1, wherein the second network entity further comprises a store holding a quality threshold value representing the predetermined threshold and means for comparing the signal quality with the predetermined threshold.

4. A wireless communications system according to claim 1, wherein the basic signal processing system is an orthogonal frequency division multiplexing system.

5. A wireless communications system according to claim 4, wherein the enhanced signal processing system is an orthogonal frequency division multiplexing system including time domain scrambling.

6. A wireless communications system according to claim 1, wherein the basic signal processing system and the enhanced signal processing system share basic processing components.

7. A wireless communications system according to claim 1, wherein the first network entity includes a receiver comprising basic processing components and enhanced processing components.

8. A wireless communications system according to claim 1, wherein the information relating to the signal quality comprises at least one of a channel quality parameter, a geometry parameter, a signal to interference, and noise parameter.

9. A wireless communications system according to claim 1, further comprising:
a third network entity setting the predetermined threshold.

10. A wireless communications system according to claim 9, wherein the third network entity comprises a radio network controller.

11. Apparatus for use in a wireless communications system, the apparatus comprising:
a transmitter with a basic signal processing system for processing a signal for transmission and an enhanced signal processing system for processing the signal for transmission; and
a system switch operable to select said enhanced signal processing system responsive to information relating to a signal quality of a communication channel in the wireless communications system.

12. Apparatus according to claim 11, further comprising:
means for storing said information relating to the signal quality.

13. Apparatus according to claim 11, which comprises
means for receiving information relating to the signal quality from another network entity in the wireless communications system.

14. Apparatus according to claim 11, further comprising:
a base station.

15. Apparatus according to claim 11, further comprising:
a first network entity providing said transmitter and a second entity providing said system switch.

16. A method of processing a signal for transmission over a wireless communication channel in a communications system, the method comprising:
detecting information relating to a signal quality of the wireless channel; and
selecting one of a basic signal processing system and an enhanced signal processing system for processing the signal for transmission over the wireless channel, wherein the enhanced system is selected when the signal quality is below a predetermined threshold.

17. A method according to claim 16, wherein the information relating to the signal quality is detected from the signal received over the wireless channel.

18. A wireless communications system comprising:
first network entity means comprising
means for monitoring a signal quality, and
means for transmitting information relating to the signal quality over a wireless channel; and
second network entity means comprising
means for transmitting having a basic signal processing system for processing a signal for transmission over the wireless channel, and
an enhanced signal processing system for processing the signal for transmission over the wireless channel, wherein the first and second networks entity means are in communication over the wireless channel and the second network entity means being responsive to said information relating to the signal quality to select the enhanced system when the signal quality is below a predetermined threshold.
